(19) United States
(12) Patent Application Publication
(10) Pub. No.: US 2023/0186398 A1
(43) Pub. Date: Jun. 15, 2023

(54) SYSTEM AND METHOD FOR FACILITATING MANAGEMENT OF HEALTHCARE CLAIMS

(71) Applicant: Glide Health, Palo Alto, CA (US)

(72) Inventors: Allister Lundberg, Palo Alto, CA (US); Bhupesh Bajaj, Palo Alto, CA (US); Dan Lodder, Palo Alto, CA (US)

(21) Appl. No.: 17/929,762

(22) Filed: Sep. 6, 2022

Related U.S. Application Data
(60) Provisional application No. 63/288,764, filed on Dec. 13, 2021.

(51) Int. Cl. G06Q 40/08

(52) U.S. Cl. CPC G06Q 40/08

(57) ABSTRACT

A system and method for facilitating management of healthcare claims is disclosed. The method includes receiving a request to inspect one or more medical claims, obtaining claim data from one or more data sources and identifying one or more business scenarios. Further, the method includes generating a set of candidate rules for each of prioritized one or more business scenarios and generating one or more recommendations based on the generated set of candidate rules, a historical context, the received request, and the obtained claim data. Furthermore, the method includes generating one or more final rules, validating the generated one or more final rules by using a predefined validation data and outputting the validated one or more final rules, the identified one or more business scenarios and the generated one or more recommendations on user interface screen of one or more electronic devices.

### EARLIEST PRIORITY DATE

This Application claims priority from a provisional patent application filed in the U.S. having Pat. Application No. 63288764, filed on Dec. 13, 2021 and titled “AUTOMATED MEDICAL BUSINESS LOGIC FOR MANAGING HEALTHCARE CLAIMS”.

### FIELD OF INVENTION

Embodiments of the present disclosure relate to healthcare billing systems and more particularly relate to a system and method for facilitating management of healthcare claims.

### BACKGROUND

In the US, billions of medical claims are submitted each year from healthcare providers to healthcare payers or insurers. However, a significant percentage of the medical claims are denied by the healthcare payers due to preventable errors. For example, in oncology, the healthcare providers have an average of 6-10% of healthcare claims denied due to errors in the medical claims, resulting in tens of millions of dollars in denials for each customer every year. Further, every healthcare provider needs to work with hundreds of different regional and national healthcare payers. Each healthcare payer has different business logic systems and different rules to approve or deny the medical claims. Additionally, each healthcare payer can change the rules throughout the year. Furthermore, healthcare provider’s staff who submit the medical claims needs to be fully up to speed on all these rules, otherwise the medical claims may be denied. Realistically, this is not possible, especially when there is staff turnover, resulting in unnecessary denials and lost revenue. Manually reviewing and resolving issues caused in denied medical claims can take weeks or even months, wasting valuable staff time, and resulting in some denials not being reviewed or paid at all.

Further, the healthcare providers typically have an average of six to ten percent of all their initial medical claims denied i.e., the medical claims that were submitted the first time to the healthcare payers for reimbursement. For these denials, typically half or more of these errors are considered actionable claims i.e., the medical claims having errors, which can be corrected and resubmitted. Conventionally, customers primarily use fixed code editing systems to address medical claims errors. The fixed code editing systems have a suite of fixed rules that are applied on the medical claims to look for errors. The problem with the fixed code editing systems is that they do not adapt to the healthcare payers’ actual behaviour, which changes over time. For example, when a new rule is introduced by the healthcare payer, the fixed code editing system is unable to detect issues with the rule unless the rule is explicitly added to the fixed code editing system. Thus, maintaining such fixed code editing systems is expensive and time consuming. Also, many practices simply do not maintain rules and use the rules as it is, which results in missing errors and higher denial rates. Furthermore, most conventional systems focus on identifying correlations in the medical claims data or building static set rules. Thus, the usefulness of the conventional systems is low when used to predict future medical claims that are likely to be denied. Also, the conventional systems fail to provide specific reasons for denial of the medical claims and specific suggestions on how to fix the denial.

Hence, there is a need for an improved system and method facilitating management of healthcare claims, in order to address the aforementioned issues.

### SUMMARY

This summary is provided to introduce a selection of concepts, in a simple manner, which is further described in the detailed description of the disclosure. This summary is neither intended to identify key or essential inventive concepts of the subject matter nor to determine the scope of the disclosure.

In accordance with an embodiment of the present disclosure, a computing system facilitating management of healthcare claims is disclosed. The computing system includes one or more hardware processors and a memory coupled to the one or more hardware processors. The memory includes a plurality of modules in the form of programmable instructions executable by the one or more hardware processors. The plurality of modules include a data receiver module configured to receive a request from one or more electronic devices associated with one or more users to inspect one or more medical claims. The one or more users are one or more healthcare providers. The plurality of modules include a data obtaining module configured to obtain claim data from one or more data sources based on the received request and one or more claim parameters. Further, the plurality of modules include a data identification module configured to identify one or more business scenarios based on one or more expected impacts, reproducibility, the received request and the obtained claim data. The identified one or more business scenarios are prioritized based on the one or more expected impacts and the reproducibility. The one or more business scenarios correspond to one or more reasons and one or more errors resulting in denial of the one or more claims. The plurality of modules also include a rule generation module configured to generate a set of candidate rules for each of the prioritized one or more business scenarios based on one or more issues, the received request and the obtained claim data. The set of candidate rules are generated by recursively generating a tiered structure of rules. The one or more issues include recurring and large cost issues. Furthermore, the plurality of modules include a recommendation generation module configured to generate one or more recommendations based on the generated set of candidate rules, a historical context, the received request and the obtained claim data. The plurality of modules include an improved rule generation module configured to generate one or more final rules based on the generated set of candidate rules, one or more inputs, the generated one or more recommendations, the received request and the obtained claim data. Further, the plurality of modules include a data validation module configured to validate the generated one or more final rules based on the received request, the obtained claim data, and a predefined validation data. The plurality of modules include a data output module configured to output the validated one or more final rules, the identified one or more business scenarios and the generated one or more recommendations on user interface screen of the one or more electronic devices. The validated one or more final rules are used to update the one or more medical claims for approval.

In accordance with another embodiment of the present disclosure, a method for facilitating management of healthcare claims is disclosed. The method includes receiving a request from one or more electronic devices associated with one or more users to inspect one or more medical claims. The one or more users are one or more healthcare providers. The method further includes obtaining claim data from one or more data sources based on the received request and one or more claim parameters. Further, the method includes identifying one or more business scenarios based on one or more expected impacts, reproducibility, the received request and the obtained claim data. The identified one or more business scenarios are prioritized based on the one or more expected impacts and the reproducibility. The one or more business scenarios correspond to one or more reasons and one or more errors resulting in denial of the one or more claims. Also, the method includes generating a set of candidate rules for each of the prioritized one or more business scenarios based on one or more issues, the received request and the obtained claim data. The set of candidate rules are generated by recursively generating a tiered structure of rules. The one or more issues include recurring and large cost issues. Further, the method includes generating one or more recommendations based on the generated set of candidate rules, a historical context, the received request and the obtained claim data. The method includes generating one or more final rules based on the generated set of candidate rules, one or more inputs, the generated one or more recommendations, the received request and the obtained claim data. Further, the method includes validating the generated one or more final rules based on the received request, the obtained claim data, and a predefined validation data. The method includes outputting the validated one or more final rules, the identified one or more business scenarios and the generated one or more recommendations on user interface screen of the one or more electronic devices. The validated one or more final rules are used to update the one or more medical claims for approval.

Embodiment of the present disclosure also provide a non-transitory computer-readable storage medium having instructions stored therein that, when executed by a hardware processor, cause the processor to perform method steps as described above.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF DRAWINGS

The disclosure will be described and explained with additional specificity and detail with the accompanying figures in which:

FIG. 1 is a block diagram illustrating an exemplary computing environment for facilitating management of healthcare claims, in accordance with an embodiment of the present disclosure;

FIG. 2 is a block diagram illustrating the exemplary computing system for facilitating management of healthcare claims, in accordance with an embodiment of the present disclosure;

FIG. 3 is a process flow diagram illustrating an exemplary process of recursively generating a tiered structure of rules, in accordance with an embodiment of the present disclosure;

FIG. 4 is a process flow diagram illustrating an exemplary operation of the computing system for facilitating management of healthcare claims, in accordance with an embodiment of the present disclosure; and

FIG. 5 is a process flow diagram illustrating an exemplary method for facilitating management of healthcare claims, in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION OF THE DISCLOSURE

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure. It will be understood by those skilled in the art that the foregoing general description and the following detailed description are exemplary and explanatory of the disclosure and are not intended to be restrictive thereof.

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

The terms “comprise”, “comprising”, or any other variations thereof, are intended to cover a non-exclusive inclusion, such that one or more devices or sub-systems or elements or structures or components preceded by “comprises... a” does not, without more constraints, preclude the existence of other devices, sub-systems, additional sub-modules. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

A computer system (standalone, client or server computer system) configured by an application may constitute a “module” (or “subsystem”) that is configured and operated to perform certain operations. In one embodiment, the “module” or “subsystem” may be implemented mechanically or electronically, so a module include dedicated circuitry or logic that is permanently configured (within a special-purpose processor) to perform certain operations. In another embodiment, a “module” or “subsystem” may also comprise programmable logic or circuitry (as encompassed within a general-purpose processor or other programmable processor) that is temporarily configured by software to perform certain operations.

Accordingly, the term “module” or “subsystem” should be understood to encompass a tangible entity, be that an entity that is physically constructed permanently configured (hardwired) or temporarily configured (programmed) to operate in a certain manner and/or to perform certain operations described herein.

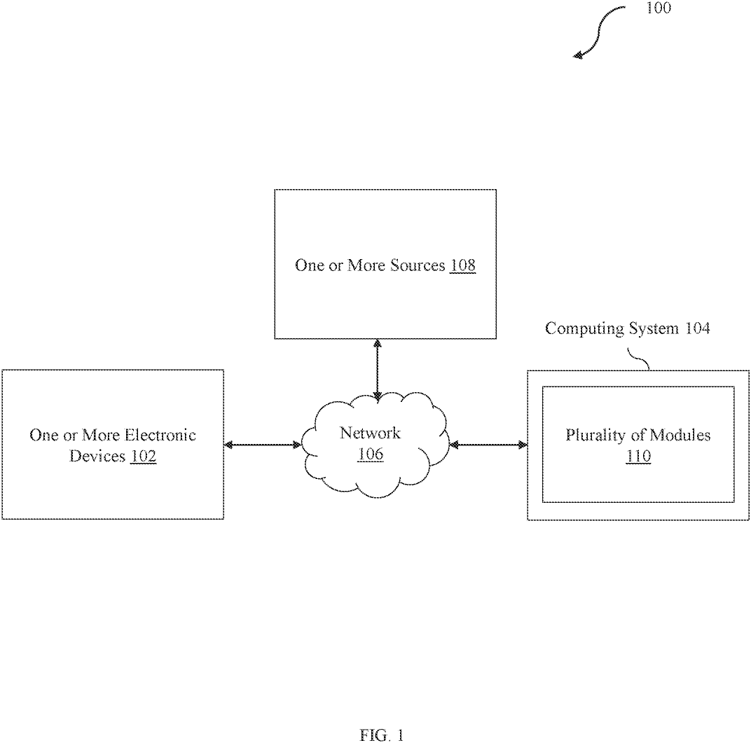

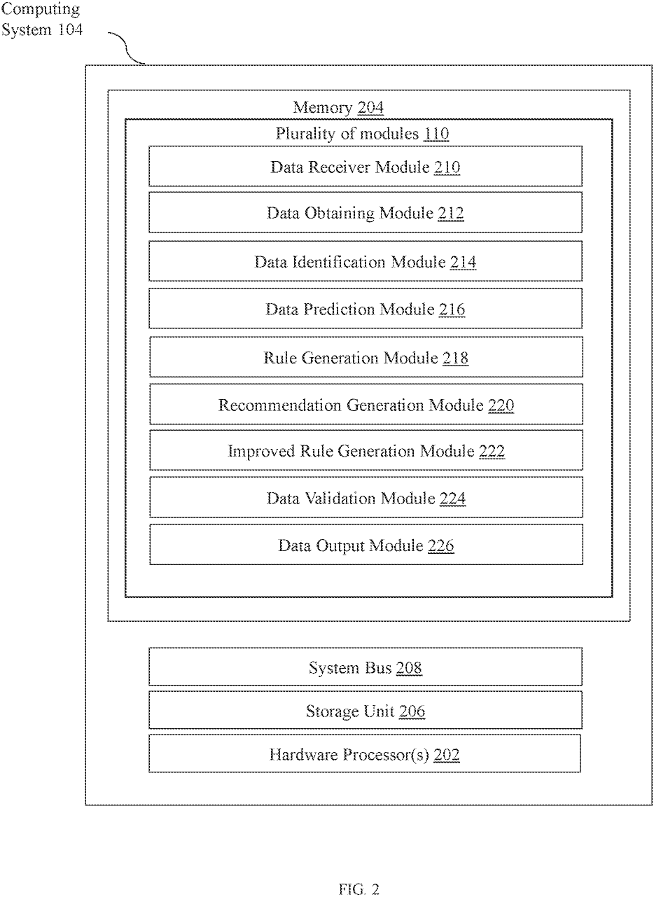

Referring now to the drawings, and more particularly to FIG. 1 through FIG. 5, where similar reference characters denote corresponding features consistently throughout the figures, there are shown preferred embodiments and these embodiments are described in the context of the following exemplary system and/or method.

FIG. 1 is a block diagram illustrating an exemplary computing environment 100 for facilitating management of healthcare claims, in accordance with an embodiment of the present disclosure. According to FIG. 1, the computing environment 100 includes one or more electronic devices 102 associated with one or more users communicatively coupled to a computing system 104 via a network 106. In an exemplary embodiment of the present disclosure, the one or more users are one or more healthcare providers. The one or more electronic devices 102 are used by the one or more users to request the computing system 104 to inspect one or more medical claims. In an embodiment of the present disclosure, the medical claim is a request that is raised by a policyholder or healthcare provider for compensation of expenses incurred for treatment. Further, the one or more electronic devices 102 are also used by the user to receive validated one or more final rules, one or more business scenarios and one or more recommendations. In an exemplary embodiment of the present disclosure, the one or more electronic devices 102 may include a laptop computer, desktop computer, tablet computer, smartphone, wearable device, smart watch, and the like. In an embodiment of the present disclosure, the computing system 104 may be hosted on a central server, such as cloud server or a remote server. In an embodiment of the present disclosure, the computing system 104 is an Automated Medical Business Logic (AMBL) which identifies cause of denied medical claims by looking at remittance codes associated with the denied claims and then generate denial rules via inductive reasoning. Further, the network 106 may be internet or any other wireless network.

Further, the computing environment 100 includes one or more data sources 108 communicatively coupled to the computing system 104 via the network 106. In an embodiment of the present disclosure, the one or more data sources 108 are external storage devices configured to store claim data. For example, the claim data includes claims and remits, national and local coverage determinations, private payer policies and prior authorization, drug coverage or any combination thereof.

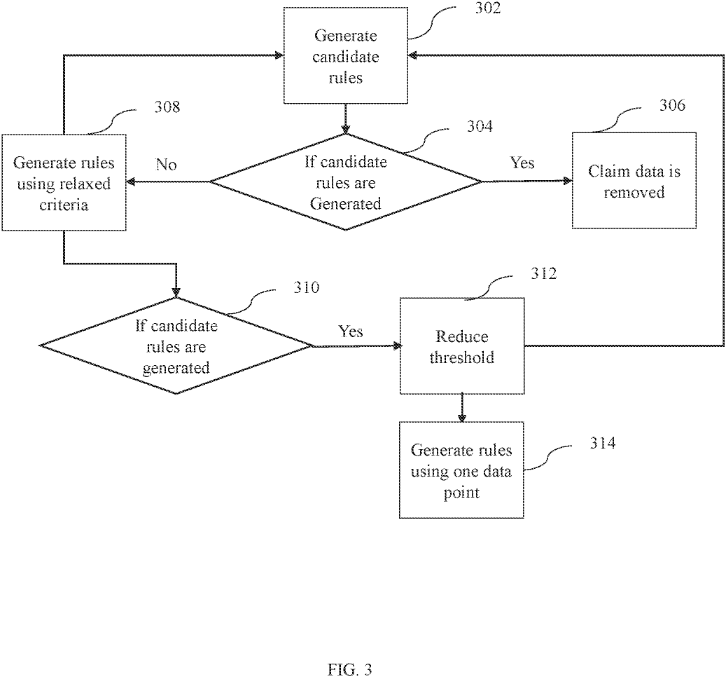

Furthermore, the one or more electronic devices 102 include a local browser, a mobile application, or a combination thereof. The one or more users may use a web application via the local browser, the mobile application, or a combination thereof to communicate with the computing system 104. In an embodiment of the present disclosure, the computing system 104 includes a plurality of modules 110. Details on the plurality of modules 110 have been elaborated in subsequent paragraphs of the present description with reference to FIG. 2.

In an embodiment of the present disclosure, the computing system 104 is configured to receive the request from the one or more electronic devices 102 associated with the one or more users to inspect the one or more medical claims. Further, the computing obtains the claim data from the one or more data sources 108 based on the received request and one or more claim parameters. The computing system 104 identifies one or more business scenarios based on one or more expected impacts, reproducibility, the received request and the obtained claim data. In an embodiment of the present disclosure, the identified one or more business scenarios are prioritized based on the one or more expected impacts and the reproducibility. The computing system 104 generates a set of candidate rules for each of the prioritized one or more business scenarios based on one or more issues, the received request and the obtained claim data. Furthermore, the computing system 104 generates one or more recommendations based on the generated set of candidate rules, a historical context, the received request and the obtained claim data. The computing system 104 generates one or more final rules based on the generated set of candidate rules, one or more inputs, the generated one or more recommendations, the received request and the obtained claim data. The computing system 104 validates the generated one or more final rules based on the received request, the obtained claim data, and a predefined validation data. The computing system 104 outputs the validated one or more final rules, the identified one or more business scenarios and the generated one or more recommendations on user interface screen of the one or more electronic devices 102.

FIG. 2 is a block diagram illustrating the exemplary computing system 104 for facilitating management of healthcare claims, in accordance with an embodiment of the present disclosure. In an embodiment of the present disclosure, the computing system 104 is an AMBL which identifies cause of denied medical claims by looking at remittance codes associated with the denied claims and then generate denial rules via inductive reasoning. Further, the computing system 104 includes one or more hardware processors 202, a memory 204 and a storage unit 206. The one or more hardware processors 202, the memory 204 and the storage unit 206 are communicatively coupled through a system bus 208 or any similar mechanism. The memory 204 comprises the plurality of modules 110 in the form of programmable instructions executable by the one or more hardware processors 202. Further, the plurality of modules 110 includes a data receiver module 210, a data obtaining module 212, a data identification module 214, a data prediction module 216, a rule generation module 218, a recommendation generation module 220, an improved rule generation module 222, a data validation module 224 and a data output module 226.

The one or more hardware processors 202, as used herein, means any type of computational circuit, such as, but not limited to, a microprocessor unit, microcontroller, complex instruction set computing microprocessor unit, reduced instruction set computing microprocessor unit, very long instruction word microprocessor unit, explicitly parallel instruction computing microprocessor unit, graphics processing unit, digital signal processing unit, or any other type of processing circuit. The one or more hardware processors 202 may also include embedded controllers, such as generic or programmable logic devices or arrays, application specific integrated circuits, single-chip computers, and the like.

The memory 204 may be non-transitory volatile memory and non-volatile memory. The memory 204 may be coupled for communication with the one or more hardware processors 202, such as being a computer-readable storage medium. The one or more hardware processors 202 may execute machine-readable instructions and/or source code stored in the memory 204. A variety of machine-readable instructions may be stored in and accessed from the memory 204. The memory 204 may include any suitable elements for storing data and machine-readable instructions, such as read only memory, random access memory, erasable programmable read only memory, electrically erasable programmable read only memory, a hard drive, a removable media drive for handling compact disks, digital video disks, diskettes, magnetic tape cartridges, memory cards, and the like. In the present embodiment, the memory 204 includes the plurality of modules 110 stored in the form of machine-readable instructions on any of the above-mentioned storage media and may be in communication with and executed by the one or more hardware processors 202.

The storage unit 206 may be a cloud storage. The storage unit 206 may store the received request, the claim data, the one or more claim parameters, the one or more business scenarios, the one or more expected impacts, the set of candidate rules, the one or more recommendations, the one or more final rules, the one or more inputs, the predefined validation data, one or more top priority problems, a set of predefined rules, a historical context, a set of auto-approved rules, one or more updated recommendations, one or more relaxed criteria, an approval status and the like.

The data receiver module 210 is configured to receive the request from the one or more electronic devices 102 associated with the one or more users to inspect the one or more medical claims. In an exemplary embodiment of the present disclosure, the one or more users are one or more healthcare providers. In an embodiment of the present disclosure, the medical claim is a request that is raised by a policyholder or healthcare provider for compensation of expenses incurred for treatment. In an exemplary embodiment of the present disclosure, the one or more electronic devices 102 may include a laptop computer, desktop computer, tablet computer, smartphone, wearable device, smart watch, and the like.

The data obtaining module 212 is configured to obtain the claim data from the one or more data sources 108 based on the received request and the one or more claim parameters. In an embodiment of the present disclosure, the one or more data sources 108 are external storage devices configured to store the claim data. For example, the claim data includes claims and remits, national and local coverage determinations, private payer policies and prior authorization, drug coverage or any combination thereof. In an exemplary embodiment of the present disclosure, the one or more claim parameters include region of patient, nation of the patient, medical scheme subscribed by the patient, region of health payer, nation of the health payer and the like. In an embodiment of the present disclosure, the claim data corresponds to disparate data.

The data identification module 214 is configured to identify the one or more business scenarios based on one or more expected impacts, reproducibility, the received request and the obtained claim data. In an embodiment of the present disclosure, the identified one or more business scenarios are prioritized based on the one or more expected impacts and the reproducibility. In an embodiment of the present disclosure, the one or more business scenarios correspond to one or more reasons and one or more errors resulting in denial of the one or more claims. The one or more reasons or causes are identified by looking at remittance codes associated with the one or more claims. In identifying the one or more business scenarios based on the one or more expected impacts, the reproducibility, the received request and the obtained claim data, the data identification module 214 integrates the claim data obtained from the one or more data sources 108 into an enriched data stream. In an embodiment of the present disclosure, data synthesis is performed to join the claim data into one signal. Further, the data identification module 214 identifies one or more top priority problems in using the one or more medical claims for reimbursement based on the one or more expected impacts, the reproducibility, the received request, and the enriched data stream. For example, the one or more top priority problems include invalid modifiers, invalid diagnosis, and the like. Furthermore, the data identification module 214 remits data associated with the identified one or more top priority problems based on the one or more expected impacts, the reproducibility, the received request, and the enriched data stream. In an exemplary embodiment of the present disclosure, the remitted data include Claims Adjustment Reason Codes (CARCs), Remittance Advice Remark Codes (RARCS) and the like.

In an embodiment of the present disclosure, the data prediction module 216 is configured to predict approval status of the one or more medical claims based on the one or more expected impacts, the reproducibility, the received request, and the obtained claim data. In an embodiment of the present disclosure, the predicted approval status is approved or rejected by one or more healthcare payers. For example, when the predicted approval status is rejected, it represents that the one or more medical claims are likely to be rejected by the one or more healthcare payers. When the predicted approval status is approved, it represents that the one or more medical claims are likely to be approved by the one or more healthcare payers.

The rule generation module 218 is configured to generate the set of candidate rules for each of the prioritized one or more business scenarios based on the one or more issues, the received request, and the obtained claim data. In an embodiment, the set of candidate rules are defined on how a particular healthcare claim should be built so that a healthcare payer accepts the rules. All the set of candidate rules are non-clinical rules. In an embodiment of the present disclosure, the computing system 104 with the help of set of candidate rules identifies one or more patterns and presents the one or more patterns to a human expert. If there is any clinical error, the human expert tunes and assess the set of candidate rules and resubmits the healthcare claims. The generated set of candidate rules are both specific yet also generalized, resulting in high precision and high recall. In an embodiment of the present disclosure, the set of candidate rules are generated by recursively generating a tiered structure of rules. For example, the one or more issues include recurring and large cost issues. In an embodiment of the present disclosure, the one or more issues are classified by using RARC and CARC codes. In an embodiment of the present disclosure, denial rules are generated via inductive reasoning. In generating the set of candidate rules for each of the prioritized one or more business scenarios based on the one or more issues, the received request and the obtained claim data, the rule generation module 218 generates the set of candidate rules for each of the prioritized one or more business scenarios based on the one or more issues, the received request, and the obtained claim data. Further, the rule generation module 218 determines if the set of candidate rules are generated successfully. The rule generation module 218 removes the obtained claim data from the storage unit 206 to avoid duplication of rules upon determining that the set of candidate rules are generated successfully. Furthermore, the rule generation module 218 generates the set of candidate rules for each of the prioritized one or more business scenarios based on the one or more issues, the received request, and the obtained claim data by using one or more relaxed criteria upon determining that the set of candidate rules are not generated successfully. The rule generation module 218 determines if the set of candidate rules are generated successfully by using the one or more relaxed criteria. Further, the rule generation module 218 removes the obtained claim data from the storage unit 206 to avoid duplication of rules upon determining that the set of candidate rules are generated successfully. The rule generation module 218 generates the set of candidate rules for each of the prioritized one or more business scenarios based on the one or more issues, the received request, the obtained claim data and by reducing a predefined threshold upon determining that the set of candidate rules are not generated successfully, and data exist for consideration. Furthermore, the rule generation module 218 generates the set of candidate rules for one or more predefined business scenarios based on a single data point and one or more additional constraints. The one or more additional constraints improve precision of the set of candidate rules. In an embodiment of the present disclosure, data including possible mixed signals is removed from the obtained claim data. In an embodiment of the present disclosure, data that is both denied and approved later is removed from consideration.

The recommendation generation module 220 is configured to generate the one or more recommendations based on the generated set of candidate rules, the historical context, the received request, and the obtained claim data. In generating the one or more recommendations based on the generated set of candidate rules, the historical context, the received request and the obtained claim data, the recommendation generation module 220 validates or tests the generated set of candidate rules by using the set of predefined rules. Further, the recommendation generation module 220 generates the one or more recommendations based on the validated set of candidate rules, the historical context, the received request, and the enriched data stream. The recommendation generation module 220 categorizes the set of candidate rules into a set of auto-approved rules and a set of hold-off rules based on predefined categorization information upon generating the one or more recommendations. In an embodiment of the present disclosure, the set of hold-off rules are rules which are uncertain and are required to be reviewed, tuned or approved by a human expert. Furthermore, the recommendation generation module 220 receives the one or more inputs from the one or more users to update the set of hold-off rules. In an embodiment of the present disclosure, the one or more inputs are received from the one or more users to improve or tune the set of hold-off rules. The recommendation generation module 220 validates the updated set of hold-off rules by using the set of predefined rules. Further, the recommendation generation module 220 generates one or more updated recommendations based on the updated set of hold-off rules, the historical context, the received request, and the enriched data stream upon validating the updated set of hold-off rules.

In an embodiment of the present disclosure, recommendations are reference points in terms of correct rules. Based on the historical context data, the computing system 104 confirms the set of candidate rules and refutes the set of candidate rules. Hypothesis of the set of candidate rules are created based on the claim data. Further, the created hypothesis of the set of candidate rules are vetted out and tested. Once the hypothesis is tested, based on parameters of testing, the set of candidate rules may pass or fail. When the computing system 104 decides the hypothesis is true, the set of candidate rules are categorized into the set of auto-approved rules and the set of hold-off rules. When the hypothesis turns out to be false, the set of candidate rules are no longer valid. The various data sets i.e., claim data may now be used to create recommendations to inform a human expert the reason behind presence of a rule or how a rule should be used based on status of the medical claim which results in successful medical claim submission. The recommendation generation module 220 uses the historical context data to identify the claim data which leads to successful medical claim submissions.

The improved rule generation module 222 is configured to generate the one or more final rules based on the generated set of candidate rules, one or more inputs, the generated one or more recommendations, the received request, and the obtained claim data. In generating the one or more final rules based on the generated set of candidate rules, the generated one or more recommendations, the one or more inputs, the received request and the obtained claim data, the improved rule generation module 222 is configured to generate the one or more final rules based on the set of auto-approved rules, the updated set of hold-off rules, the generated one or more recommendations, the generated one or more updated recommendations, the received request and the enriched data stream. In an embodiment of the present disclosure, the one or more final rules are approved rules.

The data validation module 224 is configured to validate the generated one or more final rules based on the received request, the obtained claim data, and a predefined validation data. In an embodiment of the present disclosure, the predefined validation data is used to verify the one or more final rules. In an embodiment of the present disclosure, the computing system 104 works reliably when new data is provided, which is not previously seen by the computing system 104. In an embodiment of the present disclosure, the validated one or more final rules include a set of mistakes. In an exemplary embodiment of the present disclosure, the set of mistakes include invalid medical diagnosis codes and incorrect pointers, invalid modifiers, invalid drug codes, invalid NPIs, missing HCT values, invalid addresses, missing addresses or any combination thereof. In an embodiment of the present disclosure, the validated one or more final rules are specific enough to accurately capture specific errors and reasons for which the one or more medical claims are denied but also generalized enough to capture future similar errors.

The data output module 226 is configured to output the validated one or more final rules, the identified one or more business scenarios and the generated one or more recommendations on user interface screen of the one or more electronic devices 102. In an exemplary embodiment of the present disclosure, the validated one or more final rules are used to update the one or more medical claims for approval. In an embodiment of the present disclosure, the one or more recommendations are outputted on the user interface screen stating the use of the validated one or more final rules, parameter changes in the validated one or more final rules and the like.

FIG. 3 is a process flow diagram illustrating an exemplary process of recursively generating a tiered structure of rules, in accordance with an embodiment of the present disclosure. At step 302, an attempt is made to generate the set of candidate rules using most amount of data i.e., based on the one or more issues, the received request, and the obtained claim data. At step 304, it is determined if the set of candidate rules are generated successfully. When the set of candidate rules are generated successfully, the obtained claim data is removed from the storage unit 206 to avoid duplication of rules at step 306. At step 308, the set of candidate rules are generated for each of the prioritized one or more business scenarios based on the one or more issues, the received request, and the obtained claim data by using one or more relaxed criteria upon determining that the set of candidate rules are not generated successfully. Further, step 302 is repeated. At step 310, it is determined if the set of candidate rules are generated successfully and obtained claim data still exist for consideration. At step 312, when the obtained claim data still exists for consideration and the set of candidate rules are not generated, the predefined threshold required to generate the set of candidate rules is reduced and steps 302 to 310 are run again. At step 314, the set of candidate rules are generated for one or more predefined business scenarios based on a single data point and one or more additional constraints. In an embodiment of the present disclosure, data including possible mixed signals is removed from the obtained claim data. In an embodiment of the present disclosure, data that is both denied and approved later is removed from consideration.

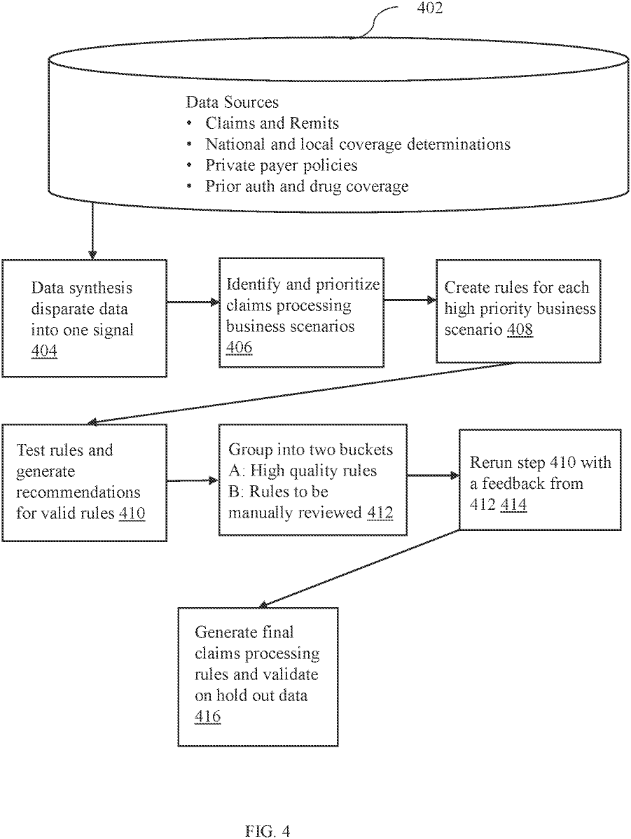

FIG. 4 is a process flow diagram illustrating an exemplary operation of the computing system 104 for facilitating management of healthcare claims, in accordance with an embodiment of the present disclosure. At step 402, the claim data including claims and remits, national and local coverage determinations, private payer policy, prior authorization and drug coverage and the like are obtained from the one or more data sources 108 based on the one or more medical claims. At step 404, data synthesis is performed to combine the obtained claim data into one signal. The data sets associated with the claim data are combined from disparate sources into one enriched data stream referred as ‘one signal’. At step 406, business scenarios and claims processing are identified and prioritized based on expected impact and reproducibility. The computing system 104 implementing the AMBL identifies top priority problems to target utilizing the one or more claims and remits various data sets such as CARC’s), RARCS and the like. At step 408, the set of candidate rules are generated for each high priority business scenario focusing on recurring and large cost issues. The computing system 104 is designed to build rules that are both specific yet generalized, resulting in high precision and high recall. This is done by recursively generating a tiered structure of the rules. At step 410, the set of candidate rules are tested, and recommendations are generated based on the historical context. At step 412, the set of candidate rules are categorized into the set of auto-approved rules i.e., high quality rules and the set of hold-off rules i.e., rules to be manually reviewed. In an embodiment of the present disclosure, the one or more inputs are received from the one or more users to update the set of hold-off rules. The updated set of hold-off rules correspond to improved or tuned rules. At step 414, the step 410 is performed again if applicable, using the improved or the tuned rules from the step 412. At step 416, the approved rules and final claims are generated, and validation data is held out. The computing system 104 using the validated data verifies the rules, works reliably when a new data set is given which is previously not seen by the AMBL.

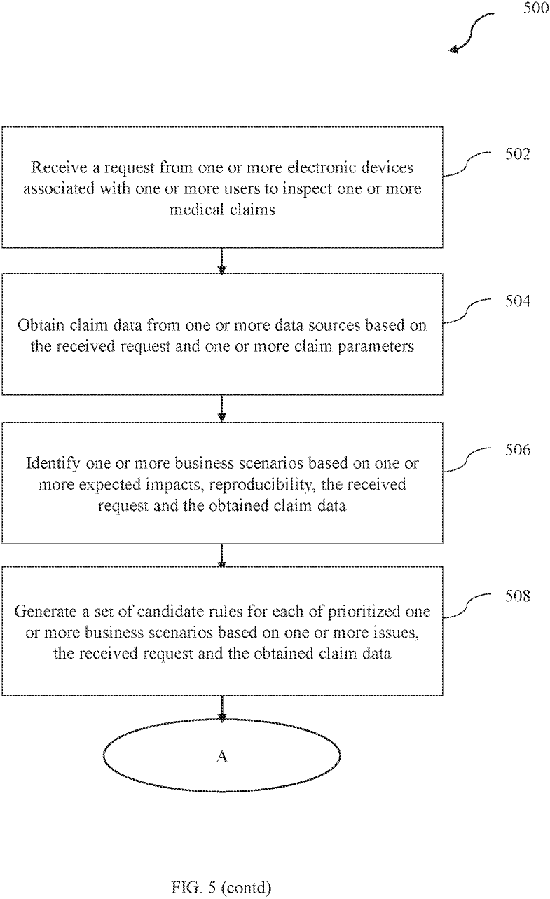

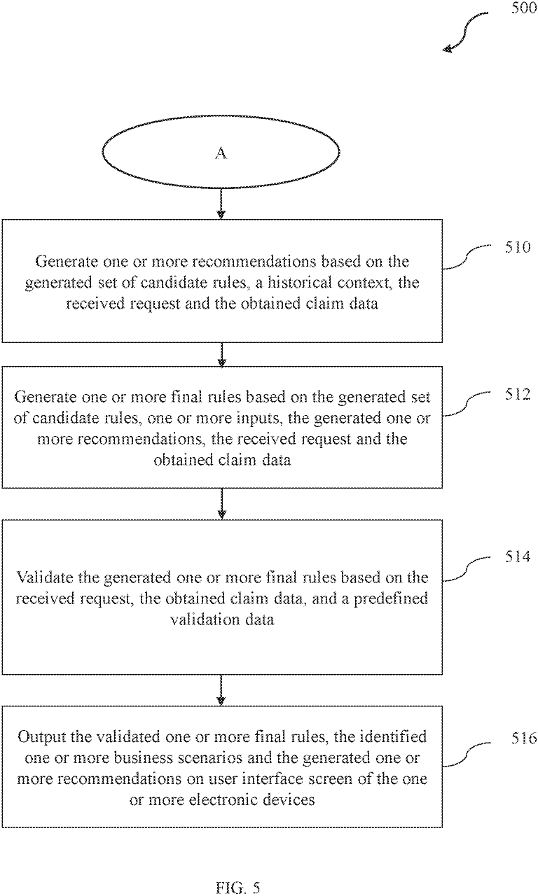

FIG. 5 is a process flow diagram illustrating an exemplary method 500 for facilitating management of healthcare claims, in accordance with an embodiment of the present disclosure. At step 502, a request is received from one or more electronic devices 102 associated with one or more users to inspect one or more medical claims. In an exemplary embodiment of the present disclosure, the one or more users are one or more healthcare providers. In an embodiment of the present disclosure, the medical claim is a request that is raised by a policyholder or healthcare provider for compensation of expenses incurred for treatment. In an exemplary embodiment of the present disclosure, the one or more electronic devices 102 may include a laptop computer, desktop computer, tablet computer, smartphone, wearable device, smart watch, and the like.

At step 504, claim data is obtained from one or more data sources 108 based on the received request and one or more claim parameters. In an embodiment of the present disclosure, the one or more data sources 108 are external storage devices configured to store the claim data. For example, the claim data includes claims and remits, national and local coverage determinations, private payer policies and prior authorization, drug coverage or any combination thereof. In an exemplary embodiment of the present disclosure, the one or more claim parameters include region of patient, nation of the patient, medical scheme subscribed by the patient, region of health payer, nation of the health payer and the like. In an embodiment of the present disclosure, the claim data corresponds to disparate data.

At step 506, one or more business scenarios are identified based on one or more expected impacts, reproducibility, the received request and the obtained claim data. In an embodiment of the present disclosure, the identified one or more business scenarios are prioritized based on the one or more expected impacts and the reproducibility. In an embodiment of the present disclosure, the one or more business scenarios correspond to one or more reasons and one or more errors resulting in denial of the one or more claims. The one or more reasons or causes are identified by looking at remittance codes associated with the one or more claims. In identifying the one or more business scenarios based on the one or more expected impacts, the reproducibility, the received request and the obtained claim data, the method 500 includes integrating the claim data obtained from the one or more data sources 108 into an enriched data stream. In an embodiment of the present disclosure, data synthesis is performed to join the claim data into one signal. Further, the method 500 includes identifying one or more top priority problems in using the one or more medical claims for reimbursement based on the one or more expected impacts, the reproducibility, the received request, and the enriched data stream. For example, the one or more top priority problems include invalid modifiers, invalid diagnosis, and the like. Furthermore, the method 500 includes remitting data associated with the identified one or more top priority problems based on the one or more expected impacts, the reproducibility, the received request, and the enriched data stream. In an exemplary embodiment of the present disclosure, the remitted data include Claims Adjustment Reason Codes (CARCs), Remittance Advice Remark Codes (RARCS) and the like.

In an embodiment of the present disclosure, the method 500 includes predicting approval status of the one or more medical claims based on the one or more expected impacts, the reproducibility, the received request, and the obtained claim data. In an embodiment of the present disclosure, the predicted approval status is approved or rejected by one or more healthcare payers. For example, when the predicted approval status is rejected, it represents that the one or more medical claims are likely to be rejected by the one or more healthcare payers. When the predicted approval status is approved, it represents that the one or more medical claims are likely to be approved by the one or more healthcare payers.

At step 508, a set of candidate rules are generated for each of the prioritized one or more business scenarios based on the one or more issues, the received request, and the obtained claim data. In an embodiment, the set of candidate rules are defined on how a particular healthcare claim should be built so that a healthcare payer accepts the rules. All the set of candidate rules are non-clinical rules. In an embodiment of the present disclosure, the computing system 104 with the help of the set of candidate rules identifies one or more patterns and presents the one or more patterns to a human expert. If there is any clinical error, the human expert tunes and assess the set of candidate rules and resubmits the healthcare claims. The generated set of candidate rules are both specific yet also generalized, resulting in high precision and high recall. In an embodiment of the present disclosure, the set of candidate rules are generated by recursively generating a tiered structure of rules. For example, the one or more issues include recurring and large cost issues. In an embodiment of the present disclosure, the one or more issues are classified by using RARC and CARC codes. In an embodiment of the present disclosure, denial rules are generated via inductive reasoning. In generating the set of candidate rules for each of the prioritized one or more business scenarios based on the one or more issues, the received request and the obtained claim data, the method 500 includes generating the set of candidate rules for each of the prioritized one or more business scenarios based on the one or more issues, the received request, and the obtained claim data. Further, the method 500 includes determining if the set of candidate rules are generated successfully. The method 500 includes removing the obtained claim data from the storage unit 206 to avoid duplication of rules upon determining that the set of candidate rules are generated successfully. Furthermore, the method 500 includes generating the set of candidate rules for each of the prioritized one or more business scenarios based on the one or more issues, the received request, and the obtained claim data by using one or more relaxed criteria upon determining that the set of candidate rules are not generated successfully. The method 500 includes determining if the set of candidate rules are generated successfully by using the one or more relaxed criteria. Further, the method 500 includes removing the obtained claim data from the storage unit 206 to avoid duplication of rules upon determining that the set of candidate rules are generated successfully. The method 500 includes generating the set of candidate rules for each of the prioritized one or more business scenarios based on the one or more issues, the received request, the obtained claim data and by reducing a predefined threshold upon determining that the set of candidate rules are not generated successfully, and data exist for consideration. Furthermore, the method 500 includes generating the set of candidate rules for one or more predefined business scenarios based on a single data point and one or more additional constraints. The one or more additional constraints improve precision of the set of candidate rules. In an embodiment of the present disclosure, data including possible mixed signals is removed from the obtained claim data. In an embodiment of the present disclosure, data that is both denied and approved later is removed from consideration.

At step 510, one or more recommendations are generated based on the generated set of candidate rules, the historical context, the received request, and the obtained claim data. In generating the one or more recommendations based on the generated set of candidate rules, the historical context, the received request and the obtained claim data, the method 500 includes validating or tests the generated set of candidate rules by using the set of predefined rules. Further, the method 500 includes generating the one or more recommendations based on the validated set of candidate rules, the historical context, the received request, and the enriched data stream. The method 500 includes categorizing the set of candidate rules into a set of auto-approved rules and a set of hold-off rules based on predefined categorization information upon generating the one or more recommendations. In an embodiment of the present disclosure, the set of hold-off rules are rules which are uncertain and are required to be reviewed, tuned or approved by a human expert. Furthermore, the method 500 includes receiving the one or more inputs from the one or more users to update the set of hold-off rules. In an embodiment of the present disclosure, the one or more inputs are received from the one or more users to improve or tune the set of hold-off rules. The method 500 includes validating the updated set of hold-off rules by using the set of predefined rules. Further, the method 500 includes generating one or more updated recommendations based on the updated set of hold-off rules, the historical context, the received request, and the enriched data stream upon validating the updated set of hold-off rules.

In an embodiment of the present disclosure, recommendations are reference points in terms of correct rules. Based on the historical context data, the computing system 104 confirms the set of candidate rules and refutes the set of candidate rules. Hypothesis of the set of candidate rules are created based on the claim data. Further, the created hypothesis of the set of candidate rules are vetted out and tested. Once the hypothesis is tested, based on parameters of testing, the set of candidate rules may pass or fail. When the computing system 104 decides the hypothesis is true, the set of candidate rules are categorized into the set of auto-approved rules and the set of hold-off rules. When the hypothesis turns out to be false, the set of candidate rules are no longer valid. The various data sets i.e., claim data may now be used to create recommendations to inform a human expert the reason behind presence of a rule or how a rule should be used based on status of the medical claim which results in successful medical claim submission. The historical context data are used to identify the claim data which leads to successful medical claim submissions.

At step 512, the one or more final rules are generated based on the generated set of candidate rules, one or more inputs, the generated one or more recommendations, the received request, and the obtained claim data In generating the one or more final rules based on the generated set of candidate rules, the generated one or more recommendations, the one or more inputs, the received request and the obtained claim data, the method 500 includes generating the one or more final rules based on the set of auto-approved rules, the updated set of hold-off rules, the generated one or more recommendations, the generated one or more updated recommendations, the received request and the enriched data stream. In an embodiment of the present disclosure, the one or more final rules are approved rules.

At step 514, the generated one or more final rules are validated based on the received request, the obtained claim data, and a predefined validation data. In an embodiment of the present disclosure, the predefined validation data is used to verify the one or more final rules. In an embodiment of the present disclosure, the computing system 104 works reliably when new data is provided, which is not previously seen by the computing system 104. In an embodiment of the present disclosure, the validated one or more final rules include a set of mistakes. In an exemplary embodiment of the present disclosure, the set of mistakes include invalid medical diagnosis codes and incorrect pointers, invalid modifiers, invalid drug codes, invalid NPIs, missing HCT values, invalid addresses, missing addresses or any combination thereof. In an embodiment of the present disclosure, the validated one or more final rules are specific enough to accurately capture specific errors and reasons for which the one or more medical claims are denied but also generalized enough to capture future similar errors.

At step 516, the validated one or more final rules, the identified one or more business scenarios and the generated one or more recommendations are outputted on user interface screen of the one or more electronic devices 102. In an exemplary embodiment of the present disclosure, the validated one or more final rules are used to update the one or more medical claims for approval. In an embodiment of the present disclosure, the one or more recommendations are outputted on the user interface screen stating the use of the validated one or more final rules, parameter changes in the validated one or more final rules and the like.

The method 500 may be implemented in any suitable hardware, software, firmware, or combination thereof.

Thus, various embodiments of the present computing system 104 provide a solution to facilitate management of healthcare claims. The computing system 104 automatically reverse engineers the business logic that healthcare payers use when approving or denying reimbursement of medical claims. The computing system 104 identifies causes of denied medical claims by looking at remittance codes associated with the medical claims and generates denial rules via inductive reasoning. The computing system 104 generates rules with high precision i.e., 90 - 99%. Further, the computing system 104 predicts denials and generates recommendation on new claims. In an embodiment of the present disclosure, the computing system 104 generates 1000+ rules per customer. These rules cover most common and most expensive mistakes including invalid medical diagnosis codes and incorrect pointers, invalid modifiers, invalid drug codes, invalid NPIs, missing HCT values, invalid, addresses missing addresses and the like. The computing system 104 automatically derives the business logic and rules that are causing the most preventable denials, allowing healthcare providers to correct errors up front and submit claims more successfully and with less rework. In an embodiment of the present disclosure, the computing system 104 is designed to continuously keep the business rules up to date when new data is received. It is designed to be run on a daily basis, and new rules and new recommendations are added or removed based on the new data from that day. Unlike conventional systems used by customers, minimal or no work is required to keep it updated. In an embodiment of the present disclosure, the computing system 104 uses a novel, tiered and recursive approach to derive rules. The challenge with finding valid rules is that they need to be specific enough to accurately capture the specific errors and reasons the claims are denied but also generalized enough to capture future similar errors. This is a tricky trade-off between keeping the rules precise but also having sufficient recall on future claims. The computing system 104 solves these challenges by generating the rules by recursively generating a tiered structure of rules. Furthermore, even after the one or more claims are already processed by a code editing system, the computing system 104 is still able to identify many additional errors with the one or more claims. For example, the computing system 104 finds 40%+ of the remaining outstanding preventable denials after the one or more medical claims are already run through the code editing system. The computing system 104 classifies the one or more issues by using the RARC and CARC codes. Further, the computing system 104 identifies problematic data columns based on business scenario, such as invalid modifiers, invalid diagnosis, and the like. The computing system 104 generates rules based on tiered hierarchy, from specific to general and from most frequent to least frequent data examples. Further, the computing system 104 validate rules using holdout data. In an embodiment of the present disclosure, the computing system 104 generates rules for application to future claims. The computing system 104 interprets how the claim data i.e., the various data sets are sectionalised, how the various data sets are broken up into parts and how essentially the various data sets are automated such that interpretation of data is autonomous and no human expert gets involved. Further, the computing system 104 essentially interprets the various data sets, makes decision based on the various data sets and self-corrects the decisions. Thus, the computing system 104 makes decisions without dependency of the human expert. Furthermore, the computing system 104 automates the process of autonomously parsing the datasets, finding patterns in that dataset and reverse engineers that dataset to create billing rules. The billing rules define how automatically the one or more medical claims should be billed so that the healthcare payer accepts the one or more medical claims. These billing rules are non-clinical rules. The billing rules are validated and are used for predicting denials of the one or more claims and then generates recommendations of potential denials on new claims.

The written description describes the subject matter herein to enable any person skilled in the art to make and use the embodiments. The scope of the subject matter embodiments is defined by the claims and may include other modifications that occur to those skilled in the art. Such other modifications are intended to be within the scope of the claims if they have similar elements that do not differ from the literal language of the claims or if they include equivalent elements with insubstantial differences from the literal language of the claims.

The embodiments herein can comprise hardware and software elements. The embodiments that are implemented in software include but are not limited to, firmware, resident software, microcode, etc. The functions performed by various modules described herein may be implemented in other modules or combinations of other modules. For the purposes of this description, a computer-usable or computer readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random-access memory (RAM), a read-only memory (ROM), a rigid magnetic disk and an optical disk. Current examples of optical disks include compact disk-read only memory (CD-ROM), compact disk-read/write (CD-R/W) and DVD.

Input/output (I/O) devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

A representative hardware environment for practicing the embodiments may include a hardware configuration of an information handling/computer system in accordance with the embodiments herein. The system herein comprises at least one processor or central processing unit (CPU). The CPUs are interconnected via system bus 208 to various devices such as a random-access memory (RAM), read-only memory (ROM), and an input/output (I/O) adapter. The I/O adapter can connect to peripheral devices, such as disk units and tape drives, or other program storage devices that are readable by the system. The system can read the inventive instructions on the program storage devices and follow these instructions to execute the methodology of the embodiments herein.

The system further includes a user interface adapter that connects a keyboard, mouse, speaker, microphone, and/or other user interface devices such as a touch screen device (not shown) to the bus to gather user input. Additionally, a communication adapter connects the bus to a data processing network, and a display adapter connects the bus to a display device which may be embodied as an output device such as a monitor, printer, or transmitter, for example.

A description of an embodiment with several components in communication with each other does not imply that all such components are required. On the contrary, a variety of optional components are described to illustrate the wide variety of possible embodiments of the invention. When a single device or article is described herein, it will be apparent that more than one device/article (whether or not they cooperate) may be used in place of a single device/article. Similarly, where more than one device or article is described herein (whether or not they cooperate), it will be apparent that a single device/article may be used in place of the more than one device or article, or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open-ended in that an item or items following any one of these words is not meant to be an exhaustive listing of such item or items or meant to be limited to only the listed item or items. It must also be noted that as used herein and in the appended claims, the singular forms “a,” “an,” and “the” include plural references unless the context clearly dictates otherwise.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the embodiments of the present invention are intended to be illustrative, but not limiting, of the scope of the invention, which is set forth in the following claims.

1. A computing system for facilitating management of healthcare claims, the computing system comprising:
one or more hardware processors; and
a memory coupled to the one or more hardware processors, wherein the memory comprises a plurality of modules in the form of programmable instructions executable by the one or more hardware processors, and wherein the plurality of modules comprises:
a data receiver module configured to receive a request from one or more electronic devices associated with one or more users to inspect one or more medical claims, wherein the one or more users are one or more healthcare providers;
a data obtaining module configured to obtain claim data from one or more data sources based on the received request and one or more claim parameters;
a data identification module configured to identify one or more business scenarios based on one or more expected impacts, reproducibility, the received request and the obtained claim data, wherein the identified one or more business scenarios are prioritized based on the one or more expected impacts and the reproducibility, and wherein the one or more business scenarios correspond to one or more reasons and one or more errors resulting in denial of the one or more claims;
a rule generation module configured to generate a set of candidate rules for each of the prioritized one or more business scenarios based on one or more issues, the received request and the obtained claim data, wherein the set of candidate rules are generated by recursively generating a tiered structure of rules, and wherein the one or more issues comprise recurring and large cost issues;
a recommendation generation module configured to generate one or more recommendations based on the generated set of candidate rules, a historical context, the received request and the obtained claim data;
an improved rule generation module configured to generate one or more final rules based on the generated set of candidate rules, one or more inputs, the generated one or more recommendations, the received request and the obtained claim data;
a data validation module configured to validate the generated one or more final rules based on the received request, the obtained claim data, and a predefined validation data; and
a data output module configured to output the validated one or more final rules, the identified one or more business scenarios and the generated one or more recommendations on user interface screen of the one or more electronic devices, wherein the validated one or more final rules are used to update the one or more medical claims for approval.

2. The computing system of claim 1, wherein the validated one or more final rules comprise a set of mistakes, and wherein the set of mistakes comprise at least one of: invalid medical diagnosis codes and incorrect pointers, invalid modifiers, invalid drug codes, invalid NPIs, missing HCT values, invalid addresses, and missingaddresses.

3. The computing system of claim 1, wherein the one or more claim parameters comprise region of patient, nation of the patient, medical scheme subscribed by the patient, region of health payer and nation of the health payer.

4. The computing system of claim 1, wherein the claim data comprises at least one of: claims and remits, national and local coverage determinations, private payer policies and prior authorization and drug coverage.

5. The computing system of claim 1, wherein in identifying the one or more business scenarios based on the one or more expected impacts, the reproducibility, the received request and the obtained claim data, the data identification module is configured to:
integrate the claim data obtained from the one or more data sources into an enriched data stream;
identify one or more top priority problems in using the one or more medical claims for reimbursement based on the one or more expected impacts, the reproducibility, the received request, and the enriched data stream; and
remit data associated with the identified one or more top priority problems based on the one or more expected impacts, the reproducibility, the received request, and the enriched data stream, wherein the remitted data comprise Claims Adjustment Reason Codes (CARCs) and Remittance Advice Remark Codes (RARCS).

6. The computing system of claim 5, wherein in generating the one or more recommendations based on the generated set of candidate rules, the historical context, the received request and the obtained claim data, the recommendation generation module is configured to:
validate the generated set of candidate rules by using a set of predefined rules;
generate the one or more recommendations based on the validated set of candidate rules, the historical context, the received request and the enriched data stream;
categorize the set of candidate rules into a set of auto-approved rules and a set of hold-off rules based on predefined categorization information upon generating the one or more recommendations;
receive the one or more inputs from the one or more users to update the set of hold-off rules;
validate the updated set of hold-off rules by using the set of predefined rules; and
generate one or more updated recommendations based on the updated set of hold-off rules, the historical context, the received request and the enriched data stream upon validating the updated set of hold-off rules.

7. The computing system of claim 6, wherein in generating the one or more final rules based on the generated set of candidate rules, the generated one or more recommendations, the one or more inputs, the received request and the obtained claim data, the improved rule generation module is configured to generate the one or more final rules based on the set of auto-approved rules, the updated set of hold-off rules, the generated one or more recommendations, the generated one or more updated recommendations, the received request and the enriched data stream.

8. The computing system of claim 1, wherein in generating the set of candidate rules for each of the prioritized one or more business scenarios based on the one or more issues, the received request and the obtained claim data, the rule generation module is configured to:
generate the set of candidate rules for each of the prioritized one or more business scenarios based on the one or more issues, the received request and the obtained claim data;
determine if the set of candidate rules are generated successfully;
remove the obtained claim data from a storage unit to avoid duplication of rules upon determining that the set of candidate rules are generated successfully;
generate the set of candidate rules for each of the prioritized one or more business scenarios based on the one or more issues, the received request and the obtained claim data by using one or more relaxed criteria upon determining that the set of candidate rules are not generated successfully;
determine if the set of candidate rules are generated successfully by using the one or more relaxed criteria;
remove the obtained claim data from the storage unit to avoid duplication of rules upon determining that the set of candidate rules are generated successfully;
generate the set of candidate rules for each of the prioritized one or more business scenarios based on the one or more issues, the received request, the obtained claim data and by reducing a predefined threshold upon determining that the set of candidate rules are not generated successfully; and
generate the set of candidate rules for one or more predefined business scenarios based on a single data point and one or more additional constraints, wherein data including possible mixed signals is removed from the obtained claim data, and wherein data that is both denied and approved later is removed from consideration.

9. The computing system of claim 1, further comprising a data prediction module configured to predict approval status of the one or more medical claims based on the one or more expected impacts, the reproducibility, the received request and the obtained claim data, wherein the predicted approval status is one of: approved and rejected by one or more healthcare payers.

10. A method for facilitating management of healthcare claims, the method comprising:
receiving, by one or more hardware processors, a request from one or more electronic devices associated with one or more users to inspect one or more medical claims, wherein the one or more users are one or more healthcare providers;
obtaining, by the one or more hardware processors, claim data from one or more data sources based on the received request and one or more claim parameters;
identifying, by the one or more hardware processors, one or more business scenarios based on one or more expected impacts, reproducibility, the received request and the obtained claim data, wherein the identified one or more business scenarios are prioritized based on the one or more expected impacts and the reproducibility, and wherein the one or more business scenarios correspond to one or more reasons and one or more errors resulting in denial of the one or more claims;
generating, by the one or more hardware processors, a set of candidate rules for each of the prioritized one or more business scenarios based on one or more issues, the received request and the obtained claim data, wherein the set of candidate rules are generated by recursively generating a tiered structure of rules, and wherein the one or more issues comprise recurring and large cost issues;
generating, by the one or more hardware processors, one or more recommendations based on the generated set of candidate rules, a historical context, the received request and the obtained claim data;
generating, by one or more hardware processors, one or more final rules based on the generated set of candidate rules, one or more inputs, the generated one or more recommendations, the received request and the obtained claim data;
validating, by the one or more hardware processors, the generated one or more final rules based on the received request, the obtained claim data, and a predefined validation data; and
outputting, by the one or more hardware processors, the validated one or more final rules, the identified one or more business scenarios and the generated one or more recommendations on user interface screen of the one or more electronic devices, wherein the validated one or more final rules are used to update the one or more medical claims for approval.

11. The method of claim 10, wherein the validated one or more final rules comprise a set of mistakes, and wherein the set of mistakes comprise at least one of: invalid medical diagnosis codes and incorrect pointers, invalid modifiers, invalid drug codes, invalid NPIs, missing HCT values, invalid addresses, and missing addresses.

12. The method of claim 10, wherein the one or more claim parameters comprise region of patient, nation of the patient, medical scheme subscribed by the patient, region of health payer and nation of the health payer.

13. The method of claim 10, wherein the claim data comprises at least one of: claims and remits, national and local coverage determinations, private payer policies and prior authorization and drug coverage.

14. The method of claim 10, wherein identifying the one or more business scenarios based on the one or more expected impacts, the reproducibility, the received request and the obtained claim data comprises:
integrating the claim data obtained from the one or more data sources into an enriched data stream;
identifying one or more top priority problems in using the one or more medical claims for reimbursement based on the one or more expected impacts, the reproducibility, the received request, and the enriched data stream; and
remitting data associated with the identified one or more top priority problems based on the one or more expected impacts, the reproducibility, the received request, and the enriched data stream, wherein the remitted data comprise Claims Adjustment Reason Codes (CARCs) and Remittance Advice Remark Codes (RARCS).

15. The method of claim 14, wherein generating the one or more recommendations based on the generated set of candidate rules, the historical context, the received request and the obtained claim data comprises:
validating the generated set of candidate rules by using a set of predefined rules;
generating the one or more recommendations based on the validated set of candidate rules, the historical context, the received request and the enriched data stream;
categorizing the set of candidate rules into a set of auto-approved rules and a set of hold-off rules based on predefined categorization information upon generating the one or more recommendations;
receiving the one or more inputs from the one or more users to update the set of hold-off rules;
validating the updated set of hold-off rules by using the set of predefined rules; and
generating one or more updated recommendations based on the updated set of hold-off rules, the historical context, the received request and the enriched data stream upon validating the updated set of hold-off rules.

16. The method of claim 15, wherein generating the one or more final rules based on the generated set of candidate rules, the generated one or more recommendations, the one or more inputs, the received request and the obtained claim data comprises generating the one or more final rules based on the set of auto-approved rules, the updated set of hold-off rules, the generated one or more recommendations, the generated one or more updated recommendations, the received request and the enriched data stream.

17. The method of claim 10, wherein generating the set of candidate rules for each of the prioritized one or more business scenarios based on the one or more issues, the received request and the obtained claim data comprises:
generating the set of candidate rules for each of the prioritized one or more business scenarios based on the one or more issues, the received request and the obtained claim data,
determining if the set of candidate rules are generated successfully;
removing the obtained claim data from a storage unit to avoid duplication of rules upon determining that the set of candidate rules are generated successfully;
generating the set of candidate rules for each of the prioritized one or more business scenarios based on the one or more issues, the received request and the obtained claim data by using one or more relaxed criteria upon determining that the set of candidate rules are not generated successfully;
determining if the set of candidate rules are generated successfully by using the one or more relaxed criteria;
removing the obtained claim data from the storage unit to avoid duplication of rules upon determining that the set of candidate rules are generated successfully;
generating the set of candidate rules for each of the prioritized one or more business scenarios based on the one or more issues, the received request, the obtained claim data and by reducing a predefined threshold upon determining that the set of candidate rules are not generated successfully; and
generating the set of candidate rules for one or more predefined business scenarios based on a single data point and one or more additional constraints, wherein data including possible mixed signals is removed from the obtained claim data, and wherein data that is both denied and approved later is removed from consideration.

18. The method of claim 10, further comprising predicting approval status of the one or more medical claims based on the one or more expected impacts, the reproducibility, the received request and the obtained claim data, wherein the predicted approval status is one of: approved and rejected by one or more healthcare payers.

19. A non-transitory computer-readable storage medium having instructions stored therein that, when executed by a hardware processor, cause the processor to perform method steps comprising:
receiving a request from one or more electronic devices associated with one or more users to inspect one or more medical claims , wherein the one or more users are one or more healthcare providers;
obtaining claim data from one or more data sources based on the received request and one or more claim parameters;
identifying one or more business scenarios based on one or more expected impacts, reproducibility, the received request and the obtained claim data, wherein the identified one or more business scenarios are prioritized based on the one or more expected impacts and the reproducibility, and wherein the one or more business scenarios correspond to one or more reasons and one or more errors resulting in denial of the one or more claims;
generating a set of candidate rules for each of the prioritized one or more business scenarios based on one or more issues, the received request and the obtained claim data, wherein the set of candidate rules are generated by recursively generating a tiered structure of rules, and wherein the one or more issues comprise recurring and large cost issues;
generating one or more recommendations based on the generated set of candidate rules, a historical context, the received request and the obtained claim data;
generating one or more final rules based on the generated set of candidate rules, one or more inputs, the generated one or more recommendations, the received request and the obtained claim data;
validating the generated one or more final rules based on the received request, the obtained claim data, and a predefined validation data; and
outputting the validated one or more final rules, the identified one or more business scenarios and the generated one or more recommendations on user interface screen of the one or more electronic devices, wherein the validated one or more final rules are used to update the one or more medical claims for approval.

20. The non-transitory computer-readable storage medium of claim 19, wherein the validated one or more final rules comprise a set of mistakes, and wherein the set of mistakes comprise at least one of: invalid medical diagnosis codes and incorrect pointers, invalid modifiers, invalid drug codes, invalid NPIs, missing HCT values, invalid addresses, and missing addresses.
